(19) United States
(12) Patent Application Publication
(10) Pub. No.: US 2023/0298299 A1
(43) Pub. Date: Sep. 21, 2023

(54) VIDEO CONFERENCE DEVICE AND VIDEO CONFERENCE SYSTEM

(71) Applicant: HIMAX TECHNOLOGIES LIMITED, Tainan City (TW)

(72) Inventors: Kuei-Hsiang Chen, Tainan City (TW); Yu-Chun Huang, Tainan City (TW); Meng-Hung Lee, Tainan City (TW); Lung-Chou Chang, Tainan City (TW)

(73) Assignee: HIMAX TECHNOLOGIES LIMITED, Tainan City (TW)

(21) Appl. No.: 17/979,778

(22) Filed: Nov. 3, 2022

Related U.S. Application Data
(60) Provisional application No. 63/321,768, filed on Mar. 20, 2022.
(60) Provisional application No. 63/335,698, filed on Apr. 27, 2022.

(51) Int. Cl. G06V 10/22; G06V 10/26; G06F 3/14; G06V 40/10; H04N 5/272

(52) U.S. Cl. CPC G06V 10/225; G06V 10/273; G06F 3/14; G06V 40/10; H04N 5/272; G06V 2201/02; H04N 23/698

(57) ABSTRACT

A video conference device may include at least one camera, at least one processor, and an interface. The at least one camera may be arranged to capture an image of a scene. The at least one processor may be arranged to: if a trigger occurs, detect a display region in the image based on a location of a pattern in the image, wherein in response to the display region being detected, the display region is excluded from the image; detect at least one specific object in the image; and extract the at least one detected specific object in the image as at least one local image. The interface may be arranged to transmit the at least one local image.

### CROSS REFERENCE TO RELATED APPLICATIONS

This application claims the benefit of U.S. provisional application No. 63/321,768, filed on Mar. 20, 2022 and U.S. provisional application No. 63/335,698, filed on Apr. 27, 2022. The entirety of each of the above-mentioned patent applications is hereby incorporated herein by reference.

### BACKGROUND OF THE INVENTION

### 1. Field of the Invention

The present invention is related to a video conference device, and more particularly, to a video conference device that excludes a display region on a display device during detection and an associated video conference system.

### 2. Description of the Prior Art

For a conventional video conference device placed in a scene (e.g. a conference room), camera(s) on the video conference device may capture a panorama image of the conference room, and the video conference device may detect at least one specific object (e.g. at least one local conference participant in the conference room) in the panorama image, to extract an image of the at least one local conference participant as at least one local image. However, since an image of at least one incorrect specific object (e.g. at least one remote conference participant) may be displayed on a display device (e.g. a projector, a television, a white board, or a display screen of a host device) in the conference room, and the camera(s) on the video conference device cannot distinguish between the at least one local conference participant and the at least one remote conference participant when capturing the panorama image of the conference room, the video conferencing device may incorrectly detect the at least one remote conference participant as the at least one local conference participant, and extract the image of the at least one remote conference participant as the at least one local image, which may result in unstable detection. As a result, a novel video conference device and an associated video conference system are urgently needed, to exclude a display region on the display device during detection.

### SUMMARY OF THE INVENTION

It is therefore an objective of the present invention to provide a video conference device that excludes a display region on a display device during detection and an associated video conference system, to address the above-mentioned problems.

According to an embodiment of the present invention, a video conference device is provided. The video conference device may include at least one camera, at least one processor, and an interface. The at least one camera may be arranged to capture an image of a scene. The at least one processor may be arranged to: if a trigger occurs, detect a display region in the image based on a location of a pattern in the image, wherein in response to the display region being detected, the display region is excluded from the image; detect at least one specific object in the image; and extract the at least one detected specific object in the image as at least one local image. The interface may be arranged to transmit the at least one local image.

According to an embodiment of the present invention, a video conference system is provided. The video conference system may include the above video conference device, and may further include a display device and a host device. The host device may be arranged to superimpose the pattern on a display image, to generate a superimposed display image, and transmit the superimposed display image to the display device, for being fully displayed on the display device.

One of the benefits of the present invention is that, no matter whether an image of at least one incorrect specific object (e.g. at least one remote conference participant) is displayed on the display device, by detecting at least one specific object (e.g. at least one local conference participant) in the panorama image that excludes the display region according to the information of the display region, the video conference device of the present invention can obtain the at least one local image (e.g. the image of the at least one local conference participant) correctly.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a video conference system according to an embodiment of the present invention.

FIG. 2a is a diagram illustrating an example of superimposing the pattern on the display image according to an embodiment of the present invention.

FIG. 2b is a diagram illustrating another example of superimposing the pattern on the display image according to an embodiment of the present invention.

FIG. 2c is a diagram illustrating still another example of superimposing the pattern on the display image according to an embodiment of the present invention.

FIG. 3 is a diagram illustrating a video conference system according to another embodiment of the present invention.

### DETAILED DESCRIPTION

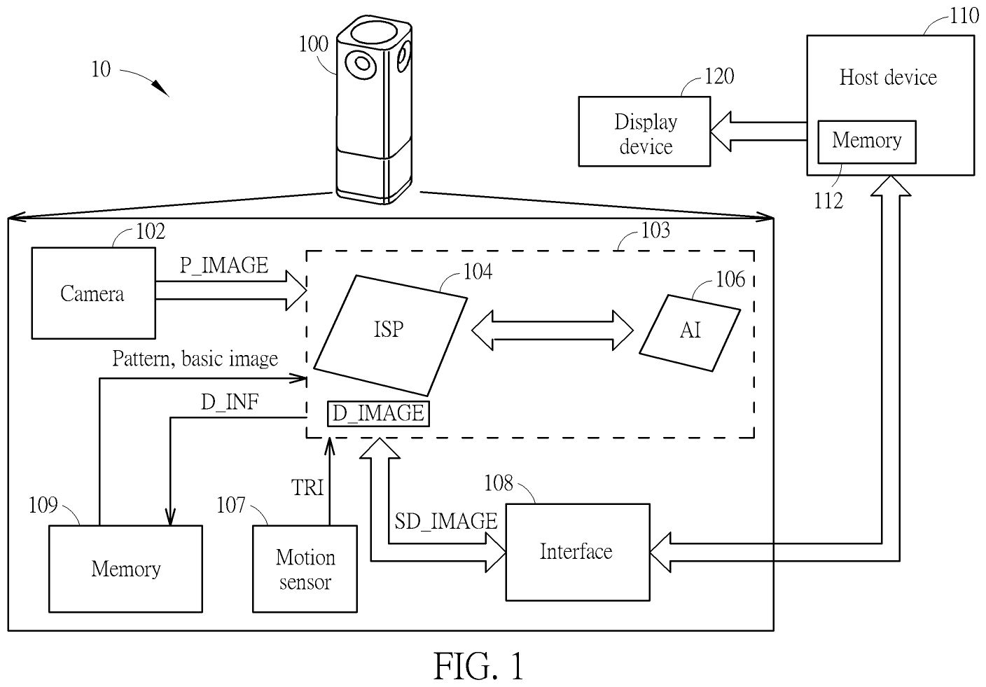

FIG. 1 is a diagram illustrating a video conference system 10 according to an embodiment of the present invention. As shown in FIG. 1, the video conference system 10 may include a video conference device 100, a host device (e.g. a cell phone, a laptop, or a desktop computer) 110, and a display device (e.g. a projector, a television (TV), a monitor, or a display screen of the host device 110) 120. The video conference device 100 may include at least one camera (e.g. one or more cameras) which may be collectively referred to as a camera 102, at least one processor 103, an interface 108, and a memory 109, wherein the at least one processor 103 may include an image processor 104 (for brevity, labeled as “ISP” in FIG. 1) and an artificial intelligence (AI) processor 106 (for brevity, labeled as “AI” in FIG. 1), but the present invention is not limited thereto. In some embodiments, the image processor 104 and the AI processor 106 may be integrated into a system on chip (SoC). The interface 108 may be a wired transmission (e.g. a universal serial bus (USB) video class transmission) or a wireless transmission (e.g. a wireless fidelity (Wi-Fi) transmission), and may be arranged to perform communication between the video conference device 100 and the host device 110.

In this embodiment, the at least one processor 103 may be arranged to superimpose a pattern on a display image D_IMAGE, to generate a superimposed display image SD_IMAGE. The pattern and a basic image may be accessed from the memory 109 of the video conference device 100. The display image D_IMAGE may be associated with the basic image in a power-up event, and the superimposed display image SD_IMAGE is transmitted to the host device 110 through the interface 108, and then is transmitted from the host device 110 to the display device 120 for being fully displayed on the display device 120. In some embodiments, the pattern and the basic image may be accessed from a memory 112 of the host device 110, and may be transmitted from the host device 110 to the at least one processor 103 through the interface 108. Examples of the pattern may include, but are not limited to: a checkerboard, a quick response (QR) code, and a highlight frame. Under a condition that the pattern is the checkerboard or the QR code, the pattern may be superimposed on each of at least two corners of the display image D_IMAGE, respectively, and the at least two corners may include two opposite corners (e.g. an upper left corner and a lower right corner, or an upper right corner and a lower left corner). Under a condition that the pattern is the highlight frame, the pattern may be superimposed on boundary of the display image D_IMAGE.

After the superimposed display image SD_IMAGE is fully displayed on the display device 120, the camera 102 may be arranged to capture an image (e.g. a panorama image P_IMAGE) of a scene, wherein the video conference system 10 (i.e. the video conference device 100, the host device 110, and the display device 120) is located in the scene. For example, the scene maybe a conference room, and a panorama image of the conference room is captured by the camera 102. Afterwards, a trigger TRI may be generated for triggering the at least one processor 103, in order to detect a display region in the panorama image P_IMAGE (i.e. a region at which the superimposed display image SD_IMAGE is located) based on a location of the pattern in the panorama image P_IMAGE.

In this embodiment, the video conference device 100 may further include a motion sensor (e.g. a gyroscope sensor) 107, wherein in response to the video conference device 100 being moved, the motion sensor 107 may be arranged to generate the trigger TRI for triggering the at least one processor 103. In some embodiments, the trigger TRI maybe generated by a specific voice command, a button pressing event of the video conference device 100, or a power-up event of the video conference device 100. In some embodiments, the host device 110 may be further arranged to transmit a trigger command to the video conference device 100, to generate the trigger TRI. In some embodiments, the trigger TRI may be automatically generated per N frames, where N is a positive integer (e.g. N≥1). If the trigger TRI occurs, the at least one processor 103 may detect the display region in the panorama image P_IMAGE based on the location of the pattern in the panorama image P_IMAGE, to obtain information of the display region (for brevity, hereinafter referred to as “information D_INF”). For example, the information D_INF may include 4 position coordinates corresponding to 4 corners of the display region in the panorama image P_IMAGE, and may be stored in the memory 109. For another example, the information D_INF may include a boundary box of the display region in the panorama image P_IMAGE, and may be stored in the memory 109.

It should be noted that the pattern may be scaled up by the at least one processor 103 until the display region in the panorama image P_IMAGE is detected or the pattern is scaled up to the maximum size. For example, in the beginning, the at least one processor 103 superimpose the smallest pattern on the display image D_IMAGE, to generate the superimposed display image SD_IMAGE for being fully displayed on the display device 120. If the display region in the panorama image P_IMAGE is not detected, the at least one processor 103 may scale up the pattern, and superimpose the scaled-up pattern on the display image D_IMAGE, to generate the superimposed display image SD_IMAGE for being fully displayed on the display device 120. The at least one processor 103 may keep scaling up the pattern, until the display region in the panorama image P_IMAGE can be detected successfully or the pattern is scaled up to the maximum size.

The at least one processor 103 may be further arranged to detect at least one specific object in the panorama image P_IMAGE that excludes the display region according to the information D_INF. Afterwards, the at least one processor 103 may generate at least one detected specific object (e.g. body/face), and extract the at least one detected specific object in the panorama image P_IMAGE that excludes the display region as at least one local image. For example, the at least one specific object maybe at least one local conference participant in the conference room (in which the video conference system 10 is located). The at least one processor 103 may perform body/face detection upon the panorama image P_IMAGE that excludes the display region according to the information D_INF, to generate an image of the at least one local conference participant, and extract the image of the at least one local conference participant as the at least one local image. In this way, the video conference device 100 of the present invention can avoid detecting the specific object in the display region, and can obtain the at least one local image (e.g. the image of the at least one local conference participant) correctly.

It should be noted that the display image D_IMAGE may also be associated with the at least one local image obtained by the video conference device 100. That is, the at least one processor 103 may be arranged to superimpose the pattern on the display image D_IMAGE that is associated with the at least one local image, to generate the superimposed display image SD_IMAGE. In addition, in some embodiments, the host device 110 may be arranged to receive at least one remote image (e.g. an image of at least one remote conference participant) from at least one remote device (e.g. one or more remote video conference devices). The at least one remote image may be received by the video conference device 100 through the interface 108, wherein the display image D_IMAGE may also be associated with the at least one remote image. That is, the at least one processor 103 may be arranged to superimpose the pattern on the display image D_IMAGE that is associated with the at least one remote image, to generate the superimposed display image SD_IMAGE.

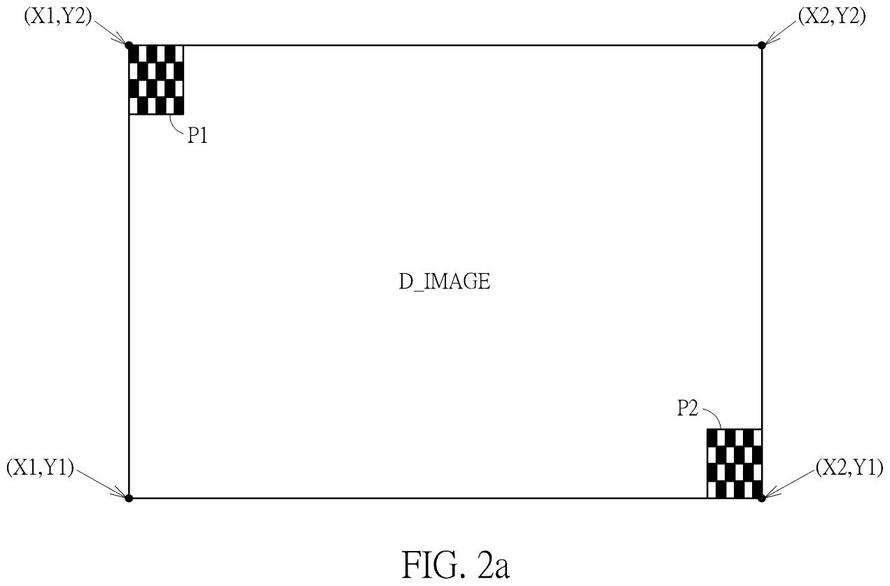

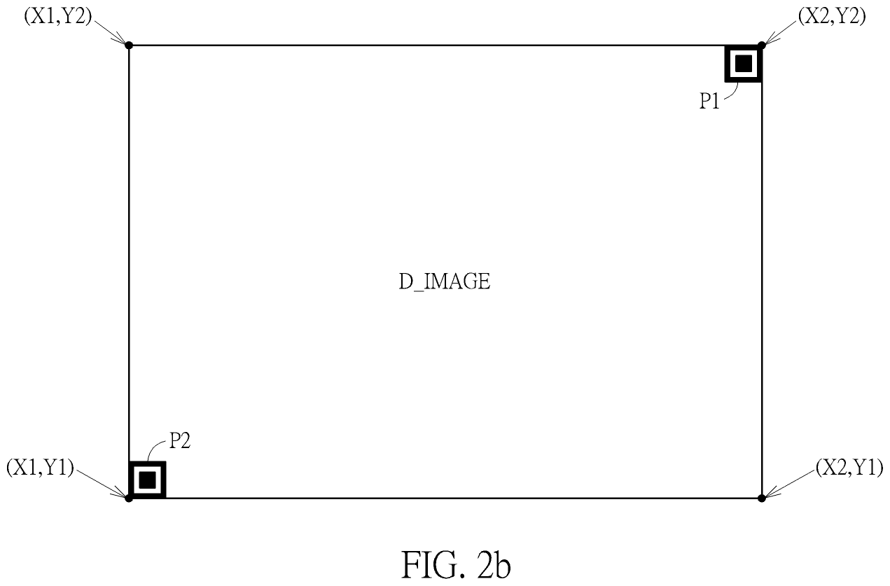

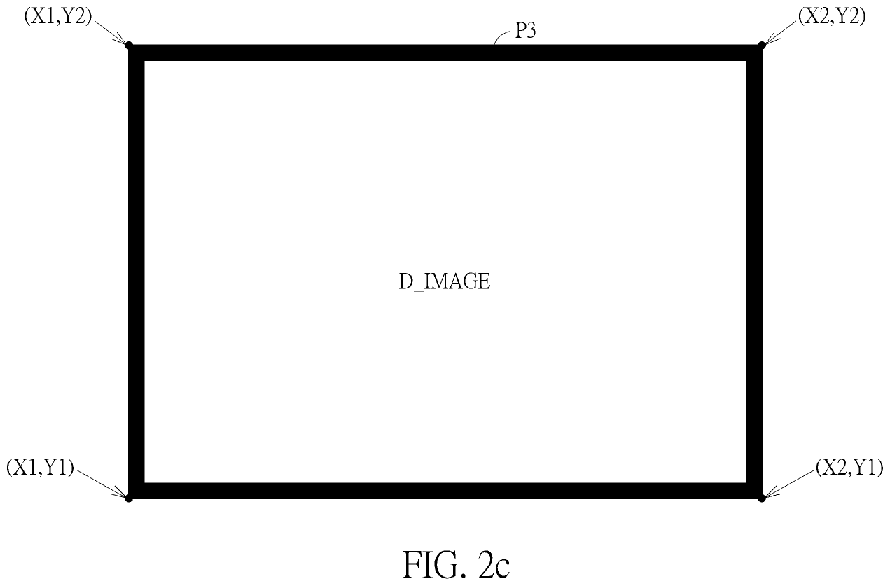

FIG. 2a is a diagram illustrating an example of superimposing the pattern on the display image D_IMAGE according to an embodiment of the present invention. As shown in FIG. 2a, the pattern may be the checkerboard, and two patterns P1 and P2 are superimposed on an upper left corner and a lower right corner of the display image D_IMAGE, to generate the superimposed display image SD_IMAGE for being fully displayed on the display device 120, wherein position coordinates of the patterns P1 and P2 in the panorama image P_IMAGE are (X1, Y2) and (X2, Y1), respectively. Afterwards, if the trigger TRI occurs, the at least one processor 103 may detect the display region in the panorama image P_IMAGE based on the location of the patterns P1 and P2 in the panorama image P_IMAGE, to obtain the information D_INF, wherein the information D_INF includes 4 position coordinates corresponding to 4 corners of the display region (i.e. (X1, Y2), (X2, Y2), (X2, Y1), and (X1, Y1)) in the panorama image P_IMAGE, and may be stored in the memory 109. For brevity, further descriptions for this embodiment are not repeated in detail here.

FIG. 2b is a diagram illustrating another example of superimposing the pattern on the display image according to an embodiment of the present invention. As shown in FIG. 2b, the pattern may be the QR code, and two patterns P1 and P2 are superimposed on an upper right corner and a lower left corner of the display image D_IMAGE, to generate the superimposed display image SD_IMAGE for being fully displayed on the display device 120, wherein position coordinates of the patterns P1 and P2 in the panorama image P_IMAGE are (X2, Y2) and (X1, Y1), respectively. Afterwards, if the trigger TRI occurs, the at least one processor 103 may detect the display region in the panorama image P_IMAGE based on the location of the patterns P1 and P2 in the panorama image P_IMAGE, to obtain the information D_INF, wherein the information D_INF includes 4 position coordinates corresponding to 4 corners of the display region (i.e. (X1, Y2), (X2, Y2), (X2, Y1), and (X1, Y1)) in the panorama image P_IMAGE, and may be stored in the memory 109. For brevity, further descriptions for this embodiment are not repeated in detail here.

FIG. 2c is a diagram illustrating still another example of superimposing the pattern on the display image according to an embodiment of the present invention. As shown in FIG. 2c, the pattern may be the highlight frame, and a pattern P3 is superimposed on boundary of the display image D_IMAGE, to generate the superimposed display image SD_IMAGE for being fully displayed on the display device 120. Afterwards, if the trigger TRI occurs, the at least one processor 103 may detect the display region in the panorama image P_IMAGE based on the location of the pattern P3 in the panorama image P_IMAGE, to obtain the information D_INF, wherein the information D_INF includes 4 position coordinates corresponding to 4 corners of the display region (i.e. (X1, Y2), (X2, Y2), (X2, Y1), and (X1, Y1)) in the panorama image P_IMAGE, and may be stored in the memory 109. For brevity, further descriptions for this embodiment are not repeated in detail here.

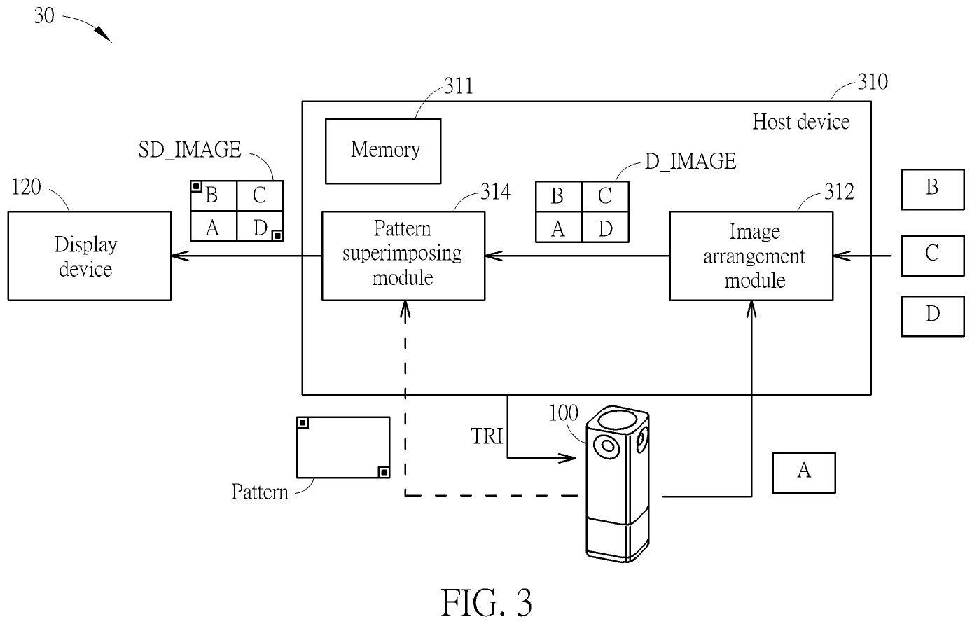

FIG. 3 is a diagram illustrating a video conference system 30 according to another embodiment of the present invention. As shown in FIG. 3, the video conference system 30 may include the video conference device 100, a host device 310, and the display device 120. The difference between the video conference system 30 shown in FIG. 3 and the video conference system 10 shown in FIG. 1 is that, compared with the host device 110 shown in FIG. 1, the host device 310 may further include an image arrangement module 312 and a pattern superimposing module 314.

It is assumed that the video conference system 30 is located in a conference room, and there is only one local conference participant A in the conference room. After the at least one local image (e.g. an image A of the local conference participant A) is obtained by the video conference device 100, the image A may be transmitted to the host device 310 through the interface 108. The host device 310 (more particularly, the image arrangement module 312) may be arranged to receive at least one remote image (e.g. images B, C, and D of three remote conference participants B, C, and D) from at least one remote device (e.g. one or more remote video conference devices), and the image arrangement module 312 may be arranged to perform image arrangement upon the images A, B, C, and D, to generate the display image D_IMAGE. As a result, the display image D_IMAGE may also be associated with the at least one local image and the at least one remote image. In this embodiment, the pattern may be stored in the memory 109 of the video conference device 100, and may be transmitted to the host device 310 (more particularly, the pattern superimposing module 314) through the interface 108, but the present invention is not limited thereto. In some embodiments, the pattern may be stored in a memory 311 of the host device 311, and the pattern superimposing module 314 may directly obtain the pattern from the memory 311.

The pattern superimposing module 314 may be arranged to superimpose the pattern on the display image D_IMAGE, to generate the superimposed display image SD_IMAGE, and transmit the superimposed display image SD_IMAGE to the display device 120, for being fully displayed on the display device 120. For brevity, further descriptions for these embodiments are not repeated in detail here.

In some embodiments, the host device 310 may be modified to only include the memory 311 and the pattern superimposing module 314, and the display image D_IMAGE may be associated with the basic image (which is accessed from the memory 311, or is received from the video conference device 100 through the interface 108). The pattern superimposing module 312 may be arranged to superimpose the pattern on the display image D_IMAGE that is associated with the basic image, to generate the superimposed display image SD_IMAGE, and transmit the superimposed display image SD_IMAGE to the display device 120, for being fully displayed on the display device 120. For brevity, further descriptions for these embodiments are not repeated in detail here.

In summary, no matter whether an image of at least one incorrect specific object (e.g. at least one remote conference participant) is displayed on the display device 120, by detecting the at least one specific object (e.g. the at least one local conference participant) in the panorama image P_IMAGE that excludes the display region according to the information D_INF, the video conference device 100 of the present invention can obtain the at least one local image (e.g. the image of the at least one local conference participant) correctly.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A video conference device, comprising:
at least one camera, arranged to capture an image of a scene;
at least one processor, arranged to:
if a trigger occurs, detect a display region in the image based on a location of a pattern in the image, wherein in response to the display region being detected, the display region is excluded from the image;
detect at least one specific object in the image; and
extract the at least one detected specific object in the image as at least one local image; and
an interface, arranged to transmit the at least one local image.

2. The video conference device of claim 1, wherein the at least one processor is further arranged to superimpose the pattern on a display image, to generate a superimposed display image, and the superimposed display image is transmitted through the interface, for being fully displayed on a display device in the scene.

3. The video conference device of claim 2, wherein the pattern is superimposed on each of at least two corners of the display image, respectively, and the at least two corners comprises two opposite corners.

4. The video conference device of claim 2, wherein the display image is associated with a basic image, the at least one local image, or at least one remote image, wherein the at least one remote image is received by the interface.

5. The video conference device of claim 1, wherein the video conference device further comprises a memory for storing information of the display region.

6. The video conference device of claim 1, wherein the interface is a wired transmission or a wireless transmission.

7. The video conference device of claim 1, wherein the at least one processor is further arranged to scale up the pattern until the display region in the image is detected.

8. The video conference device of claim 1, wherein the pattern is a highlight frame superimposed on boundary of a display image, and the display image is fully displayed on a display device in the scene.

9. The video conference device of claim 1, wherein the video conference device further comprises:
a motion sensor, arranged to generate the trigger.

10. The video conference device of claim 1, wherein the trigger is generated by a specific voice command, a button pressing event of the video conference device, or a power-up event of the video conference device, or is automatically generated per N frames, where N is an integer.

11. A video conference system comprising the video conference device of claim 1, and further comprising:
a display device; and
a host device, arranged to superimpose the pattern on a display image, to generate a superimposed display image, and transmit the superimposed display image to the display device, for being fully displayed on the display device.

12. The video conference system of claim 11, wherein the pattern is superimposed on each of at least two corners of the display image, respectively, wherein the at least two corners comprises two opposite corners.

13. The video conference system of claim 11, wherein the host device is further arranged to receive at least one remote image from at least one remote device, and perform image arrangement upon the at least one remote image and the at least one local image, to generate the display image.

14. The video conference system of claim 11, wherein the pattern is accessed from a memory in one of the host device and the video conference device.

15. The video conference system of claim 11, wherein the trigger is generated by a specific voice command, a button pressing event of the video conference device, a power-up event of the video conference device, or a command from the host device, or is automatically generated per N frames, where N is an integer.
